(19) United States
(12) Patent Application Publication
(10) Pub. No.: US 2016/0214908 A1
(43) Pub. Date: Jul. 28, 2016

(54) HIGH TEMPERATURE WITHSTAND SILVER PLATED SURFACE STRUCTURE FOR HEAT DISSIPATION CERAMIC SUBSTRATE

(71) Applicant: TA-I TECHNOLOGY CO., LTD., Taoyuan (TW)

(72) Inventors: Tsai-Pao CHIANG, Taoyuan (TW); Mao-Sung TSAO, Taoyuan (TW); Hsih-Hsien YANG, Taoyuan (TW)

(21) Appl. No.: 14/602,638

(22) Filed: Jan. 22, 2015

(51) Int. Cl. C04B 41/52; C23C 28/02; C04B 41/51

(52) U.S. Cl. CPC C04B 41/52; C04B 41/5111; C23C 28/02

(57) ABSTRACT

Disclosed is a high temperature withstand silver plated surface structure for heat dissipation ceramic substrate used to provide a surface for mounting a LED die unit on the surface of the substrate. The surface of the substrate is covered with a silver cover layer composed of a reduction nickel layer, a reduction palladium layer and a reduction silver layer stacked in order, or a reduction nickel layer, a reduction palladium layer and a replacement silver layer stacked in order. With this structure the silver layer on the substrate is able to keep away from deterioration or color change by instantaneous high temperature rise during the process of performing eutectic bonding of the flip chip LED die unit on the substrate, or by high ambient temperature caused by a long term use of the LED die unit so as to stabilize the LED quality.

### BACKGROUND OF THE DISCLOSURE

1. Field of the Disclosure

The presently disclosed new utility model relates to a heat dissipation ceramic substrate, and more particularly to a silver layer structural material applied on the surface of a heat dissipation ceramic substrate able to keep away from deterioration or color change by the instantaneous high temperature rise during the process of performing eutectic bonding of flip chip LED dies on the substrate, or by high ambient temperature caused by a long term use of LED.

2. Description of the Prior Art

Keeping pace with rapid development of the electronic industry, the circuit layout on the circuit board becomes higher and more congested, and there arises the problem of difficulty to get rid of the accumulated exhaust heat on the board. As the heat dissipation ability of the circuit board not only affects the quality of an electrical circuit, it also has relation to the durability of an electrical appliance, the aforesaid difficulty of heat dissipation must be overcome at any rote to meet with the requirement of more complicated operation features of the circuit board and tendency of the electrical appliance miniaturization.

In a conventional method, the heat producing element is set on the heat dissipation metal plated layer intercalated by a layer of the heat conducting adhesive resin or guayule rubber so as to conduct the high amount of heat generated by the operation of the heat producing element to the metal wiring via the heat conducting adhesive resin or guayule rubber, and further to the ceramic substrate so as to complete heat dissipation. Incidentally, in this manner, it may bring about the problem of causing heat burden to the heat producing element due to insufficient adhesive force of the heat conducting elements or inadequate heat dissipation cause by the gap existing on the bonding interface.

Development of the LED technology is a today's in fashion industry. It is a popular production process in use nowadays to adhere directly the LED dies to a substrate, and then mount the substrate on a circuit board together with the LED dies. Conventionally, for the purpose of upgrading the luminous intensity of the LED, it is a ordinary practice to cover the substrate's surface with a silver layer, this silver layer material may be a reduction silver or a replacement silver. Usually, the thickness of the former is 0.2˜3.0 μM, and the latter is 0.2˜2.0 μM. Generally speaking, the reduction silver has the merits of better compactness for its substrate without forming replacement perforations, while the replacement silver is advantageous for its low cost and requiring only simple but stable chemicals in use.

However, such a traditional practice of merely covering reduction silver of the replacement silver on the substrate is only applicable to the temperature of the conventional LED bonding by adhesion, which is about 150° C. In the meantime, the eutectic bonding process for LED dies requires a higher temperature about 280˜320° C. Under such a high temperature range, the traditional reduction or replacement silver is very easy to deteriorate and change its color owing to mutual metal diffusion resulting in severely degrading the quality of LED.

In view of the foregoing situation, the applicant of the patent herein conducted intensive research based on many years of experience gained through professional engagement in the manufacturing of the related products, with continuous experimentation and improvement culminating in the development of the improved structure which will be described below.

### SUMMARY OF THE DISCLOSURE

Accordingly, it is an object of the present disclosure to provide a high temperature withstand silver plated surface structure for heat dissipation ceramic substrate for mounting LED dies thereon, wherein the silver plated cover layer is composed of a reduction nickel layer a reduction palladium layer and a reduction silver layer.

It is another object of the present disclosure to provide a high temperature withstand silver plated surface structure for heat dissipation ceramic substrate for mounting LED dies thereon, wherein the silver plated cover layer is composed of a reduction nickel layer, a reduction palladium layer and a replacement silver layer.

### BRIEF DESCRIPTION OF THE DRAWINGS

The accompanying drawings, which are included to provide a further understanding of the disclosure and incorporated in and constitute a part of this specification, illustrate embodiments of the disclosure and together with the description serve to explain the principles of the disclosure, wherein:

FIG. 1 is a cross sectional view of the new utility model according to the present disclosure.

FIG. 2 is an enlarged fragmentary view of part A in FIG. 1.

FIG. 3 is a cross sectional view of another embodiment according to the present disclosure.

### DETAILED DESCRIPTION OF THE PREFERRED EMBODIMENTS

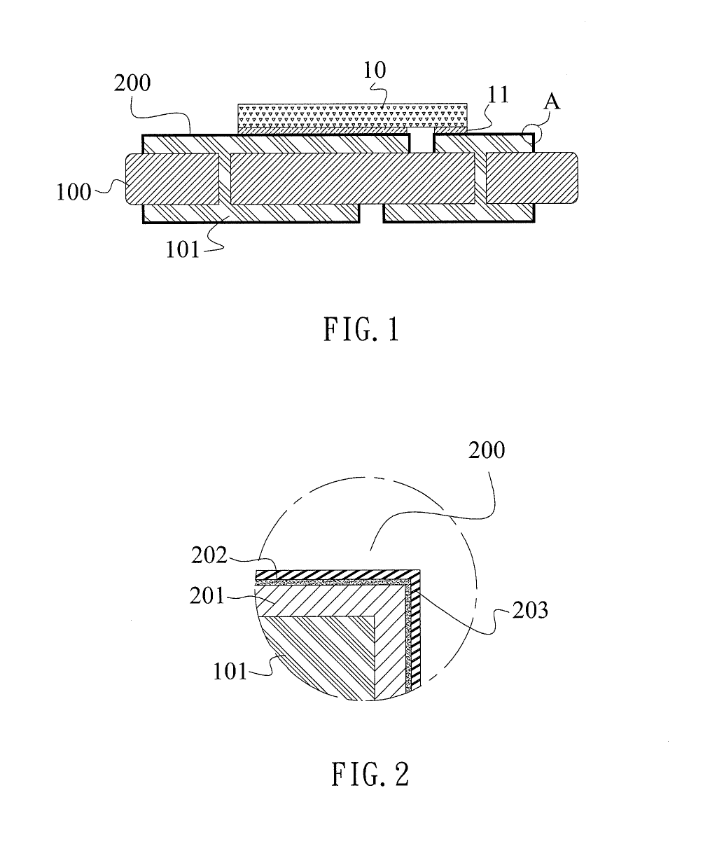

Referring to FIG. 1, the surface of a heat dissipation ceramic substrate 100 for mounting LED dies is composed of an electroplated copper layer 101, a silver cover layer 200 enclosing the outward surface of the electroplated copper layer 101, and LED die unit 10 is mounted on the silver cover layer 200, and an electrode 11 is formed between the LED die unit 10 and the silver cover layer 200.

Referring to FIG. 2 together with FIG. 1, the silver cover layer 200 is formed of three stacked layers of different materials including a reduction nickel layer 201 as the bottom layer, a reduction palladium layer 202 as the middle layer, and a reduction silver layer 203 as the upper layer.

It is preferable that the reduction nickel layer 201 has a thickness 1˜8 μm, the reduction palladium layer 202 has a thickness 0.01˜0.2 μm, and the reduction silver layer 203 has a thickness 0.2˜2.0 μm.

By way of adhering the reduction nickel layer 201 on the surface of the electroplated copper layer 101 provided on the surface of the heat dissipation ceramic substrate 100, it can prevent the electroplated copper layer 101 to diffuse its copper material in high ambient temperature. And by way of intercalating the reduction palladium layer 202 between the reduction nickel layer 201 and the reduction silver layer 203, it can prevent diffusion of the reduction nickel layer 201 and the reduction silver layer 203 in the high ambient temperature.

By doing so, in an instantaneous high temperature environment at the instance the LED die unit 10 is adhered onto the substrate, or under the high temperature surroundings caused by a long time operation of the LED, the reduction silver layer 203 is able to avoid deterioration without changing its color, and the LED assures its quality stably.

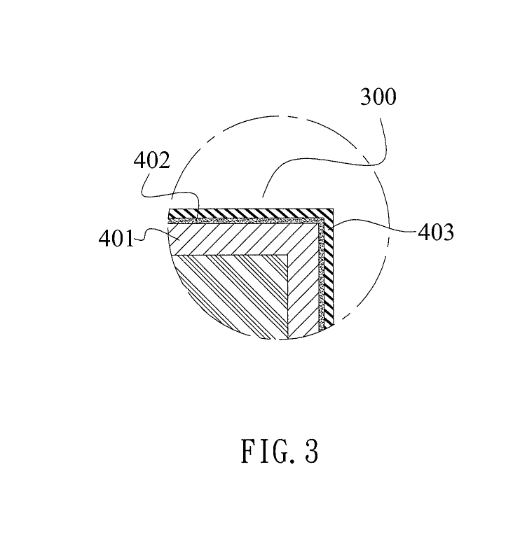

Referring to FIG. 3, it is allowable to cover the surface of the electroplated copper layer 101, which being plated on the ceramic substrate 100, with a silver cover layer 300 composed of a reduction nickel bottom layer 401, a reduction palladium middle layer 402 and a replacement upper silver layer 403, e.g. it means the reduction upper silver layer is replaced by the replacement silver layer. Similarly, the reduction nickel layer 401 has a thickness of 1˜8 μm, the reduction palladium layer 402 has a thickness of 0.01˜0.2 μm, and the reduction silver layer 403 has a thickness of 0.2˜1.0 μm.

Above description is only one of many preferred embodiments of the present new utility model. Practically, for the surface structure of the new utility model, the silver covered layer may only be composed of the bottom reduction nickel layer and the upper replacement silver layer, or the bottom reduction nickel layer and the upper reduction silver layer.

It is understood that the present disclosure is a high level technical creation and by no means, simply utilizes conventional technology or knowledge known prior to the application for patent, or can easily made by persons skilled in the art. The disclosure has neither been published or put to public use, nor displayed in an exhibition. Therefore the present disclosure is entitled for patent.

It is apparent to a person skilled in the arts that the basic idea or the disclosure can be implemented in many different ways. The disclosure and its embodiments are thus not restricted to the examples described above, but may vary with scope of the claims.

1. High temperature withstand silver plated surface structure for heat dissipation ceramic substrate, used to provide a surface for mounting a LED die unit on said ceramic substrate, said structure being formed of an electroplated copper layer, a silver cover layer covering on the surface of said electroplated copper layer, said silver cover layer being composed of a reduction nickel layer, a reduction palladium layer and a reduction or a replacement silver layer; wherein with this structure, said reduction or replacement silver layer is able to keep away from deterioration or color change by instantaneous high temperature rise during the process of performing eutectic bonding of said flip chip LED die unit on said substrate, or by high ambient temperature caused by a long term use of said LED die unit so as to stabilize said LED quality.

2. The surface structure of claim 1, wherein said reduction nickel layer is covered on the surface of said electroplating copper layer, said reduction palladium layer is covered on the outward surface of said reduction nickel layer, and said reduction silver layer is covered on the outward surface of said reduction palladium layer.

3. The surface structure of claim 1, wherein said reduction nickel layer has a thickness 1˜8 μm, said reduction palladium layer has a thickness 0.01˜0.2 μm, and the reduction silver layer has a thickness 0.2˜1.0 μm.

4. The surface structure of anyone as claimed in claim 1 to 3, wherein said silver layer which forms said silver cover layer is a replacement silver layer.

5. The surface structure of claim 4, wherein said replacement silver layer has a thickness 0.2˜1.0 μm.

6. High temperature withstand silver plated surface structure for heat dissipation ceramic substrate, used to provide a surface for mounting a LED die unit on said ceramic substrate, said structure being formed of an electroplated copper layer, said silver cover layer being composed of a bottom reduction nickel layer and a upper reduction silver layer, or composed of a bottom reduction nickel layer and a upper replacement silver layer.
